(19) United States
(12) Patent Application Publication
(10) Pub. No.: US 2024/0051735 A1
(43) Pub. Date: Feb. 15, 2024

(54) A BARRIER SYSTEM

(71) Applicant: VARDEN PROCESS PTY LTD, Braeside, Victoria (AU)

(72) Inventors: Mark APPLEFORD, Braeside, Victoria (AU); Stuart GORDON, Braeside, Victoria (AU); Connor LOWNDES, Braeside, Victoria (AU); Liam METHVEN, Braeside, Victoria (AU); Boon Mian TEO, Braeside, Victoria (AU)

(21) Appl. No.: 18/266,384

(22) PCT Filed: Dec. 9, 2021
(86) PCT No.: PCT/AU2021/051470

§ 371 Date: Jun. 9, 2023

(30) Foreign Application Priority Data
Dec. 9, 2020 (AU) 2020904558

(51) Int. Cl. B65D 85/804; B65D 65/40; B65D 65/46; B65D 81/24; D21H 27/10; D21H 21/16; D21H 19/44; D21H 19/40; D21H 19/12; D21H 19/28; D21H 19/80; D21J 3/00; D21J 1/08

(52) U.S. Cl. CPC B65D 85/8043; B65D 65/40; B65D 65/466; B65D 81/24; D21H 27/10; D21H 21/16; D21H 19/44; D21H 19/40; D21H 19/12; D21H 19/28; D21H 19/80; D21J 3/00; D21J 1/08; B65D 2565/387

(57) ABSTRACT

A packaging material is provided including a substrate, and an oxygen transmission inhibiting layer that is carried by the substrate. The oxygen transmission inhibiting layer is formed of a composite material including a linear polysaccharide medium within which one or more additives are dispersed. The composite material is capable of forming a substantially continuous film to provide a barrier to transmission of oxygen gas. The oxygen transmission inhibiting layer is configured within the packaging material at a thickness that is efficacious in inhibiting the transmission of oxygen gas therethrough. A packaging device has two or more component parts, at least one of which is formed of the packaging material. The component parts of the packaging device are shaped and/or configured to be assembled to define an interior region within which goods are to be contained.

### FIELD OF THE INVENTION

The present invention relates to a barrier system for packaging materials, and to packaging materials that incorporate a barrier system. The present invention also relates to methods of forming packaging materials.

### BACKGROUND

In this specification, the term “goods” refers to products that deteriorate (in other words, degrade, decay, perish and/or decompose) over time, and which are most desirable for their intended use with the least deterioration. Thus, “goods” includes food and beverage products for human or animal consumption; pharmaceuticals, nutraceuticals (also known as “bioceuticals”, or “functional foods”), and dietary supplements for human or animal use; cosmetics; and various garden and household products that are intended for use by humans/animals but not for ingestion. It is to be understood that this is not an exhaustive list of products that are “goods”.

It is known that some goods deteriorate by exposure to various fluids, including atmospheric gases, water vapour, and liquid water. Minimizing the exposure of such goods to these fluids is a significant factor in maximizing the shelf life. For these reasons, packaging materials for goods that deteriorate are often formed with barriers that block or inhibit transmission of fluids that contribute to deterioration (which, for the purposes of this application, are referred to as “harmful fluids”), and thus prolong the shelf life of the goods. In this context, two fluids that are commonly harmful to goods are oxygen gas, and water vapour. Consequently, the performance of packaging materials (including single-materials, blended materials, and laminates) can be characterized by Oxygen Transmission Rate (“OTR”), and/or by Water Vapour Transmission Rate (“WVTR”, which is also known as Moisture Vapour Transmission Rate).

Packaging materials that are made entirely from plastics, or that include plastic components are commonly used because they can provide, either alone or in combination, desirable WVTR and OTR barriers. Plastics used in packaging materials are predominantly oil-based and increasingly considered undesirable because of their unsustainable environmental cost. Bio-plastics are known, but these are also considered undesirable in some jurisdictions due to challenges/difficulties associated with recycling and/or composting/(bio)degrading the waste materials.

Some plastic materials and metal foils are known to have OTR and/or WVTR values that are desirable for use as packaging materials. However, for packaging materials generally, materials that are highly ranked for OTR value do not necessarily correlate to high ranking in WVTR values, and vice versa. Further, packaging materials for goods that are to be ingested need to be compatible with those goods that are contained therein (so as to mitigate adverse interactions between the goods and the packaging materials). Consequently, packaging materials are often formed blending/combining (including laminating, co-forming, co-moulding, etc.) multiple constituent materials to achieve desired characteristics, including oxygen and/or water vapour transmission rates.

Some packaging materials can be recycled, but there are significant energy, time and/or material costs involved in the recycling processes to obtain usable materials. Recycling of packaging materials that are formed of blended materials requires separation into the individual constituent materials, which increases the complexity of the recycling processes, to the point where recycling becomes unviable. Consequently, a substantial portion of packaging material is discarded to landfill.

Packaging materials that are made from biologically-produced natural resources can be compostable, and thus considered sustainable, which is desirable. However, such packaging materials generally have high WVTR and OTR values; in other words, have poor water vapour and oxygen barrier properties.

It is known to incorporate thin coatings of plastics/bioplastics on base materials derived from biologically-produced natural resources to achieve desired barrier performance whilst minimizing the use of oil-based materials. However, the blended nature of the materials compromises the ability to be recycled/composted.

Composting of biodegradable products is an efficient way of processing waste, particularly because composting tends to involve localised waste management practices with short-distance cartage of the waste. Further, composted material can be redistributed to agricultural producers, rather than the waste being stored in landfill.

There is a need to address the above, and/or at least provide a useful alternative.

### SUMMARY

There is provided a packaging material that includes:
a substrate; and
an oxygen transmission inhibiting layer that is carried by the substrate, the oxygen transmission inhibiting layer being formed of a composite material comprising a linear polysaccharide medium within which one or more additives are dispersed to thereby facilitate formation of a substantially continuous film of the composite material that is capable of providing a barrier to transmission of oxygen gas,
wherein the oxygen transmission inhibiting layer is configured within the packaging material at a thickness that is efficacious in inhibiting the transmission of oxygen gas therethrough.

In at least some embodiments, at least one of the additives forms bonds with the linear polysaccharide medium, wherein the bonds contribute to at least one of: the formation, and resilience of the substantially continuous film. Bonds that form between the linear polysaccharide medium and additives within the composite material can be physical and/or covalent bonds.

Preferably, the linear polysaccharide medium is formed by a process involving at least partial deacetylation of a long-chain polymer of an amide derivative of monosaccharide glucose. More preferably, the amide derivative of monosaccharide glucose includes N-Acetylglucosamine. In at least some embodiments, the linear polysaccharide medium is formed by a process involving at least partial deacetylation of chitin.

In certain embodiments, the linear polysaccharide medium is chitosan.

The amide derivative of monosaccharide glucose can additionally include beta glucan molecules. Alternatively or additionally, the linear polysaccharide medium in the form of at least partially deacetylated chitin can include beta glucan molecules. The chitin can be derived from fungi. The fungus can be selected from fungi within the genus Aspergillus, and/or from fungi within the genus Agaricus. In some examples, the chitin is sourced from Aspergillus niger. In some other examples, the chitin is sourced from Agaricus bisporus. The chitin can alternatively or additionally be derived from crustaceans. The chitin can be a blend of chitins derived from different sources.

In at least some embodiments, the linear polysaccharide medium includes N-Acetylglucosamine. In certain embodiments in which the linear polysaccharide medium is chitosan. The chitosan preferably has a low molecular weight. The chitosan can have a molecular weight in the range of 5 to 200 kilodaltons. Preferably, the chitosan has a molecular weight in the range of 10 to 100 kilodaltons.

In some alternative embodiments, the linear polysaccharide medium includes N-Acetylglucosamine in solution with a solvent. Preferably, the solvent is acidic. The solvent may include water that is adjusted to an acidic pH by the addition of an inorganic or organic acid. More preferably, the inorganic or organic acid is a carboxylic acid. Even more preferably, the carboxylic acid is any one or more of acetic acid, citric acid, lactic acid, malic acid, and tartaric acid.

In certain examples, the oxygen transmission inhibiting layer is made from a solution that includes at least one organic compound that acts as a plasticiser during formation of the oxygen transmission inhibiting layer.

The additives of the composite material can include plant-derived compounds. In at least some forms, the plant-derived compounds are in particle form, in fibre form, or a combination thereof. In at least some embodiments, the plant-derived compounds are cellulose. In certain embodiments, the cellulose is substantially in fibre form. The fibres can be subjected to a refinement process that involves lengthwise shearing of individual fibres. Alternatively or additionally, the refinement process alters dimensional characteristics of individual fibres.

Alternatively or additionally, the additives include one or more plasticisers for the linear polysaccharide medium, and/or contribute to the hydrophobicity of the composite material.

Preferably, the oxygen transmission inhibiting layer is formed to an average thickness in the range of 7.5 to 60 μm. More preferably, the oxygen transmission inhibiting layer is formed to an average thickness of at least 10 μm. Even more preferably, the oxygen transmission inhibiting layer is formed to an average thickness in the range of 15 to 30 μm. Alternatively or more particularly, the oxygen transmission inhibiting layer is formed on the substrate at a thickness such that the oxygen transmission rate of the packaging material is less than 6 cubic centimetres per metre squared per day (cm³/m²/day), at 23° C., 50% relative humidity. In some embodiments, the oxygen transmission inhibiting layer is formed on the substrate at a thickness such that the oxygen transmission rate of the packaging material is less than 3 cubic centimetres per metre squared per day (cm³/m²/day), at 23° C., 50% relative humidity.

In at least some embodiments, the packaging material includes at least one interposing material that at least partly separates composite material of the oxygen transmission inhibiting layer from the substrate. In some embodiments, the interposing material inhibits transmission of water vapour through the packaging material. Alternatively or additionally, interposing material is selected for its ability to bind with composite material of the oxygen transmission inhibiting layer.

In at least some embodiments, the interposing material is assembled to form at least one intermediate layer that is between the substrate and the oxygen transmission inhibiting layer in contact with one or both of the substrate and the oxygen transmission inhibiting layer. In embodiments in which the interposing material is in contact with the substrate, microscopic depressions in the boundary of the substrate that are oriented towards the oxygen transmission inhibiting layer are substantially filled by interposing material.

In certain embodiments, the interposing material is formed at a thickness to form a contiguous layer of material between the substrate and the oxygen transmission inhibiting layer. Preferably, the interposing material is formed to a thickness in the range of 15 to 60 μm. More preferably, the interposing material is formed to a thickness in the range of 30 to 45 μm.

Preferably, the interposing material is assembled into first intermediate layer that: includes a first set of one or more compounds, at least one of which is insoluble in water, is a solid at Standard Ambient Temperature; and is configured within the packaging material at a thickness that is efficacious in inhibiting the transmission of water vapour therethrough.

Alternatively or preferably, the first set of compounds includes one or more base compounds, wherein each base compound is an ester of a long-chain alcohol and a fatty acid.

Preferably, the base compounds include one or more waxes. The wax or waxes of the first layer are preferably plant-derived.

In some embodiments, the base compounds include candelilla wax. In some alternative embodiments, the base compounds include carnauba wax. Alternatively or additionally, the base compounds are a blend of two or more waxes.

The first set of compounds can include one or more interfacial energy modifying additives that facilitate increased interlayer adhesion between the first intermediate layer and the oxygen transmission inhibiting layer, and/or facilitate formation of the oxygen transmission inhibiting layer on the first intermediate layer during manufacture of the packaging material. In some examples, the interfacial energy modifying additives include any one or more of: surface active polymers, emulsifiers, and surfactants. The interfacial energy modifying additives can include compounds derived from 1,4-anhydrosorbitol, or a mixture of compounds that include 1,4-anhydrosorbitol. More particularly, the interfacial energy modifying additives include compounds derived from sorbitan. In some alternative examples, the interfacial energy modifying additives include oleic acid.

The first set of compounds can include interfacial energy modifying additives in a ratio of up to 30% by weight to the base compounds. In some examples, the material of the first layer can include interfacial energy modifying additives in a ratio of up to 8% by weight to the base compounds.

Alternatively or additionally, the first set of compounds can include particles that are dispersed within the base compounds, the particles providing barriers to transmission of water vapour through the interposing material, and/or favourably modifying adhesion to the substrate or oxygen transmission inhibiting layer.

Particles dispersed within the base compounds can be any one or more of: primary particles, aggregates, agglomerates, and crystalline solids.

Particles dispersed within the base compounds can be predominantly compounds of non-metals.

In some examples, at least some of the particles dispersed within the base compounds are hydrophobic, thereby inhibiting transmission of water vapour through the interposing material by hydrophobicity.

In some examples in which at least some particles dispersed within the base compounds are crystalline solids, the crystalline structure of those particle provides a barrier to water vapour transmission.

The particles dispersed within the base compounds can include any of: silica-based particles, aluminium-based particles, magnesium-based particles, crystalline boron nitrides, and crystalline carbons.

In certain embodiments, the interposing material within the first layer is a mixture of the first set of compounds.

In some embodiments, the interposing material is additionally assembled into a second intermediate layer that includes a second set of one or more compounds, wherein:
the second set of compounds includes one or more of the compounds in the first set of compounds,
the second intermediate layer is between the first intermediate layer and the oxygen transmission inhibiting layer, and the oxygen transmission inhibiting layer is adhered to the second intermediate layer.

The interfacial energy of the interposing material within the first intermediate layer may be higher than the interfacial energy of the interposing material within the second intermediate layer.

Preferably, the second set of compounds include all the compounds of the first set of compounds, and at least one modifying agent that, when combined with the first set of compounds, increases the interfacial energy of the first set of compounds. In some examples, the second set of compounds is a mixture of the first set of compounds and the modifying agent.

The modifying agent can include any one or more of: polyether compounds, glycol, galacturonic acid, sugar-alcohol-derived compounds, ozone, and solvent.

Where present, the polyether compounds may include polyethylene glycol.

Where present, the galacturonic acid may be in the form of pectin.

Where present, the sugar-alcohol-derived compounds may be sorbitol or sorbitan.

The interposing material of the first layer preferably has improved filling properties with respect to the material of the substrate, compared with the filling properties with respect to the composite material when the composite material is applied directly to material of the substrate.

Alternatively or additionally, the interposing material of the first layer has improved binding properties with the material of the substrate, compared with the binding properties of the composite material when applied directly to material of the substrate.

Preferably, the geometric variation of the material boundary interface profile between the interposing material and the oxygen transmission inhibiting layer is less than the geometric variation of the material boundary interface profile between the substrate and the interposing material, wherein the geometric variations are determined from a mean averaged over the respective material boundary interface profile, and wherein the geometric variation is measured in a direction that is normal to the local tangential plane of the material boundary interface.

Preferably, the material boundary interface profile between the interposing material and the oxygen transmission inhibiting layer has a mean of the absolute values of the interface profile geometric deviation that is lower than the mean of the absolute values of the geometric deviation in the material boundary interface profile between the substrate and the interposing material, wherein geometric deviations are measured in a direction that is normal to the local tangential plane of the material boundary.

In at least some embodiments, the packaging material includes a protective layer that is assembled into a substantially continuous film to provide a barrier between the oxygen transmission inhibiting layer and the atmosphere to thereby inhibit interaction between atmospheric water vapour and the oxygen transmission inhibiting layer. The protective layer can be in contact with the oxygen transmission inhibiting layer. Alternatively or additionally, the protective layer can define a surface of the packaging material. In some instances, the protective layer can define an external surface of the packaging material. In some instances the protective layer can alternatively or additionally define an internal surface of the packaging material.

In certain embodiments, the oxygen transmission inhibiting layer is between the substrate and the protective layer.

Preferably, the protective layer inhibits interaction between the oxygen transmission inhibiting layer and atmospheric water vapour. Even more preferably, the protective layer is hydrophobic.

The protective layer preferably includes polymer material. In some embodiments, the protective layer includes poly(lactic-co-glycolic acid). The poly(lactic-co-glycolic acid) can be formed from lactic acid and glycolic acid at a monomer ratio in the range of 40:60 to 85:15. More preferably, the poly(lactic-co-glycolic acid) can be formed from lactic acid and glycolic acid at a monomer ratio in the range of 50:50 to 75:25. Alternatively or additionally, the poly(lactic-co-glycolic acid) can be formed from lactic acid and glycolic acid, with a greater proportion of lactic acid monomer present at polymerization.

Preferably, the protective layer is formed to an average thickness in the range of 2.5 to 100 μm. More preferably, the protective layer is formed to an average thickness in the range of 5 to 50 μm.

In at least some embodiments, the substrate is formed of pulp fibres that have been processed so as to be assembled into a predetermined shape, and treated to form bonds between the pulp fibres within the substrate, whereby the substrate is able to at least partly retain its shape in an unsupported condition.

There is also provided a packaging device that is formed of packaging material as described above, the packaging device being shaped and/or configured to define an interior region within which goods are to be contained.

There is also provided a packaging device that has two or more component parts, at least one of which is formed of packaging material as described above, the component parts of the packaging device being shaped and/or configured to be assembled to define an interior region within which goods are to be contained.

The packaging device can be configured with the substrate being positioned between the oxygen transmission inhibiting layer and the interior region. Alternatively, the packaging device can be configured with the oxygen transmission inhibiting layer being positioned between the substrate and the interior region.

In some embodiments, the packaging device includes:
a container portion having a body that defines the interior region, and an annular flange surrounding an entrance to the interior region, and
a lid portion with a peripheral edge region that is to be joined to the annular flange to thereby enclose the interior region,
whereby the container and lid portions are formed separately, and when so joined form a capsule within which to contain an aliquot of the goods,
and wherein at least one of the container portion and the lid portion are formed of packaging material as described above.

There is also provided packaging sheet material that is formed of packaging material as described above, the packaging sheet material being configured to have an external surface, and an internal surface that is to be oriented inwardly with respect to goods packaged using the packaging sheet material.

The packaging sheet material can be configured with the substrate being positioned between the oxygen transmission inhibiting layer and the internal surface. Alternatively, the packaging sheet material can be configured with the substrate being positioned between the oxygen transmission inhibiting layer and the external surface.

Preferably, the packaging sheet material has indicia on the internal surface and/or on the external surface, whereby the internal and external surfaces of the packaging sheet material can be identified from the indicia.

In some embodiments, the packaging sheet material is a planar sheet.

In some alternative embodiments, the internal surface is non-planar, and/or the external surface is non-planar. The internal and external surfaces may be shaped such that the thickness of the packaging sheet material varies in a length and/or width direction.

There is also provided a packaging material that includes:
a substrate; and
a protective layer that includes poly(lactic-co-glycolic acid), that is assembled into a substantially continuous film that is carried by the substrate, and that defines a surface of the packaging material,
wherein the protective layer has a thickness that is efficacious in inhibiting interaction between atmospheric water vapour and the packaging material beneath the protective layer.

The poly(lactic-co-glycolic acid) can be formed from lactic acid and glycolic acid at a monomer ratio of approximately 50:50. Alternatively, the poly(lactic-co-glycolic acid) can be formed from lactic acid and glycolic acid, with a greater proportion of lactic acid monomer present at polymerization.

Preferably, the protective layer is formed to an average thickness in the range of 2.5 to 100 μm. More preferably, the protective layer is formed to an average thickness in the range of 5 to 50 μm.

In some instances, the protective layer can define an external surface of the packaging material. In some instances the protective layer can alternatively or additionally define an internal surface of the packaging material.

In certain embodiments, the packaging material further includes one or more intermediate layers between the substrate and the protective layer, wherein the intermediate layers are efficacious in inhibiting the transmission of at least one of: oxygen gas, and water vapour therethrough.

In at least some embodiments, the substrate is formed of pulp fibres that have been processed so as to be assembled into a predetermined shape, and treated to form bonds between the pulp fibres within the substrate, whereby the substrate is able to at least partly retain its shape in an unsupported condition.

There is also provided a method of making a packaging material, the method involving:
forming a substrate in a predetermined shape, the substrate being able to at least partly retain the predetermined shape in an unsupported condition;
applying a first layer to a surface of the substrate;
surface treating the applied first layer to improve the receptiveness of the first layer to bonding; and
applying a second layer on the treated surface of the first layer, the second layer being efficacious in inhibiting the transmission of at least one of: oxygen gas, and water vapour therethrough,
wherein the surface treating step facilitates adhesion of the second layer to the first layer.

There is also provided a method of making a packaging material, the method involving:
forming a substrate in a predetermined shape, the substrate being able to at least partly retain the predetermined shape in an unsupported condition;
applying a first layer to a surface of the substrate;
surface treating the applied first layer to remove contaminants on the surface of the applied first layer; and
applying a second layer on the treated surface of the first layer, the second layer being efficacious in inhibiting the transmission of at least one of: oxygen gas, and water vapour therethrough,
wherein the surface treating step facilitates adhesion of the second layer to the first layer.

There is also provided a method of making a packaging material, the method involving:
forming a substrate in a predetermined shape, the substrate being able to at least partly retain the predetermined shape in an unsupported condition, and having a first surface with a first surface roughness;
applying a first layer to the first surface of the substrate;
surface treating the applied first layer, such that the applied first layer has a treated surface with a second surface roughness; and
applying a second layer on the treated surface of the first layer,
wherein the second surface roughness is less that the first surface roughness.

There is also provided a method of making a packaging material, the method involving:
forming a substrate in a predetermined shape, the substrate being able to at least partly retain the predetermined shape in an unsupported condition;
applying a first layer to a surface of the substrate;
surface treating the applied first layer such that the geometric variations of the treated surface of the first layer is less than the geometric variations of the surface of the substrate on which the first layer is formed; and
applying a second layer on the treated surface of the first layer,
wherein the geometric variations are determined from a mean surface in respect of the respective treated surface/substrate surface, and wherein the geometric variations are measured in a direction that is either normal to, or parallel to the local tangential plane intersecting an external surface of the substrate.

There is also provided a method of making a packaging material, the method involving:
forming a substrate in a predetermined shape, the substrate being able to at least partly retain the predetermined shape in an unsupported condition;
applying a first layer to a surface of the substrate;
surface treating the applied first layer such that the mean of absolute values of the profile height deviations of the treated surface of the first layer is less than the mean of absolute values of the profile height deviations of the surface of the substrate on which the first layer is formed; and
applying a second layer on the treated surface of the first layer,
wherein profile height deviations are measured in a direction that is normal to the local tangential plane intersecting an external surface of the packaging material.

There is also provided a method of making a packaging material, the method involving:
forming a substrate in a predetermined shape, the substrate being able to at least partly retain the predetermined shape in an unsupported condition;
applying a first layer to a surface of the substrate;
surface treating the applied first layer to increase the surface energy of the first layer; and
applying a second layer on the treated surface of the first layer, the second layer being efficacious in inhibiting the transmission of at least one of: oxygen gas, and water vapour therethrough,
wherein the surface treating step facilitates application of the second layer to form a film of the second layer material over the first layer.

In some embodiments, the surface treating step involves applying heat to the exposed surface of the applied first layer.

The surface treating step may involve plasma treatment.

The surface treating step can involve transferring energy from an energy source to the surface of the applied first layer. In some embodiments, the energy source uses plasma to impart changes in the surface of the applied first layer. In some alternative embodiments, the energy source uses ultraviolet light.

Alternatively, the surface treating step can involve contacting exposed surface of the applied first layer to one or more chemicals that interact with the first layer material to thereby induce a change in the properties of the exposed surface.

In certain embodiments, the first layer is formed of a raw material that includes one or more compounds that are insoluble in water, and the first layer is a solid at Standard Ambient Temperature, and the method further involves:
transferring the raw material onto the surface of the substrate in a powder form, and
exposing the applied raw material to heat for a predetermined period, such that the applied raw material melts and flows to form a continuous layer on the surface of the substrate, and is subsequently allowed to solidify.

In some alternative embodiments, the first layer is formed of a raw material that includes one or more compounds that are insoluble in water, and the first layer is a solid at Standard Ambient Temperature, and the method further involves:
liquifying the raw material,
transferring the liquified raw material onto the surface of the substrate, and
allowing the liquified raw material to solidify, and thereby form a continuous layer on the surface of the substrate.

The step of transferring the liquified raw material may involve spraying the liquified raw material onto the surface of the substrate. The step of transferring the liquified raw material may alternatively involve forming a bath of the liquified raw material, and dipping the substrate into the bath to thereby transfer raw material to the surface of the substrate. The step of transferring the liquified raw material may involve delivering the liquified raw material in a laminar flow onto the surface of the substrate.

In certain embodiments of the method, the surface treating step occurs before solidifying of the liquified raw material of the applied first layer is complete.

The step of forming the substrate may involve:
creating a slurry of pulp fibres suspended in liquid,
forming a wet pulp fibre pre-form on a mould that has a shape to correspond with the predetermined shape in the formed substrate, and
treating the wet pulp fibre pre-form to reduce the water content and thereby form the substrate as a moulded pulp fibre item.

Preferably, the method further involves:
forming a protective layer over the second layer, the protective layer being formed of materials that in the completed packaging material inhibit interaction between atmospheric water vapour and the second layer.

The step of forming the protective layer may involve applying a solution consisting of solvent and poly(lactic-co-glycolic acid) to the second layer, and evaporating the solvent to form a film of the protective layer materials.

The step of forming the protective layer may additionally involve heat treating the film of the protective layer materials to close pores in the poly(lactic-co-glycolic acid).

Alternatively or additionally, the step of forming the protective layer may involve controlling the rate of evaporation of solvent to mitigate the formation of pores in the poly(lactic-co-glycolic acid) as the solvent evaporates.

### BRIEF DESCRIPTION OF THE DRAWINGS

In order that the invention may be more easily understood, embodiments will now be described, by way of example only, with reference to the accompanying drawings, in which:

FIG. 1: is a perspective view of a packaging device according to an embodiment of the present invention;

FIG. 2: is a vertical section view of the container portion of the packaging device of FIG. 1;

FIG. 3: is an enlarged view of Region A of FIG. 2;

FIG. 4: is a flow chart of a method of making a packaging material according to another embodiment of the present invention;

FIG. 5: is a schematic representation of Region B of FIG. 3, showing a portion of the surface of the substrate during a stage of the method of FIG. 4;

FIG. 6: is a chart showing the absolute value of geometric deviations within portion D of the surface shown in FIG. 5;

FIG. 7: is a schematic representation of Region C of FIG. 3, showing a portion of the treated surface of the first layer during a stage of the method of FIG. 4;

FIG. 8: is a chart showing the absolute value of geometric deviations within portion E of the interface shown in FIG. 7;

FIG. 9: is a horizontal section view of the packaging device of FIG. 1; and

FIG. 10: is a schematic representation of Region F of FIG. 9, showing a portion of the material boundary interface profile between the substrate and the first layer.

### DETAILED DESCRIPTION

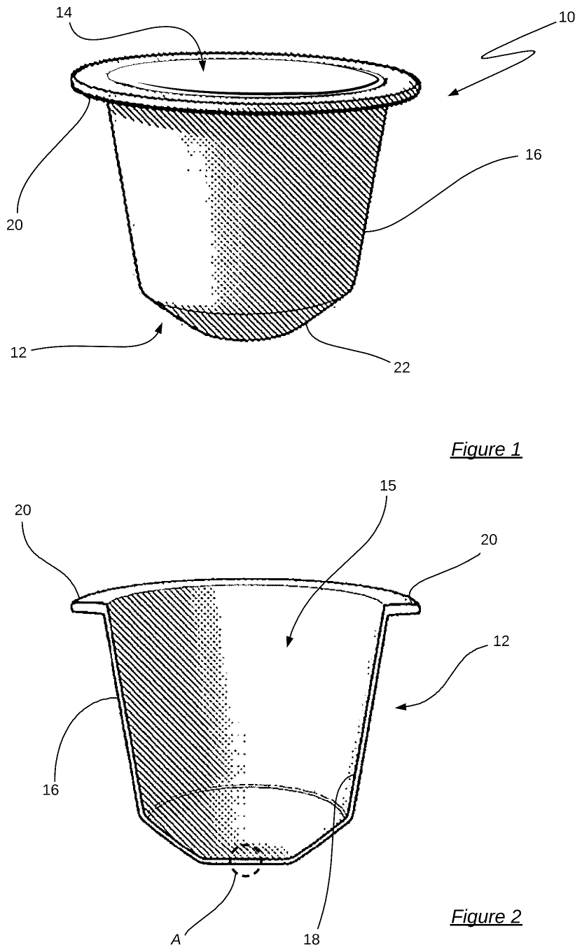

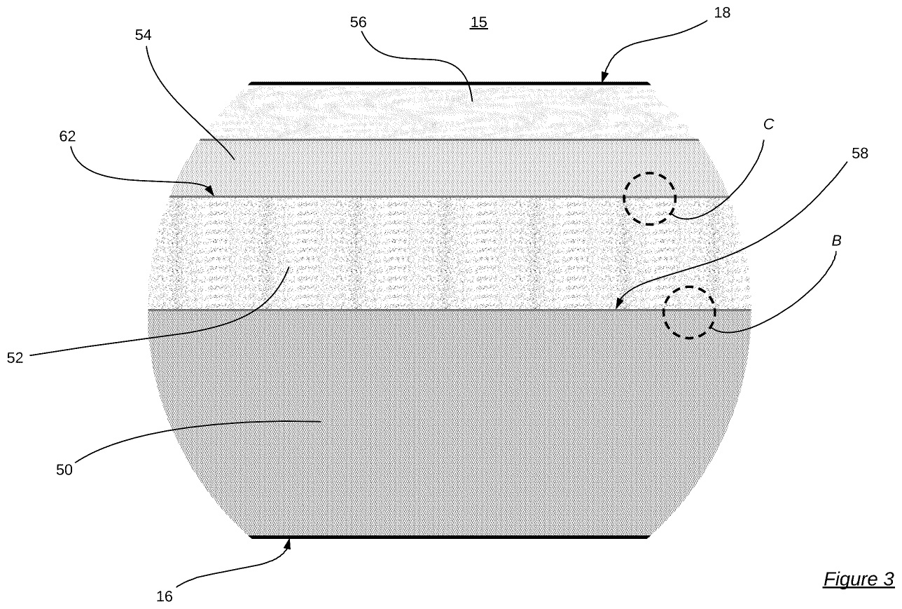

FIGS. 1 and 2 show a packaging device 10 according to an embodiment. The packaging device 10 includes two component parts: a container portion 12, and a lid portion 14.

As shown in FIG. 2, the container portion 12 is concave so as to define an interior region 15 within which goods are to be contained. To this end, the container portion 12 of this illustrative example has an external surface 16, and an internal surface 18. An annular flange 20 surrounds an entrance to the interior region 15. The lid portion 14 similarly has an internal surface (not shown) and an external surface 22. The diameter of the lid portion 14 is the same as the outer diameter of the annular flange 20. In the assembled packaging device 10, the annular flange 20 is joined to the peripheral edge region of the lid portion 14.

In this example, each of the container portion 12 and lid portion 14 are formed of packaging material according to an embodiment. FIGS. 3 to 6 show (schematically) detail of the packaging material as used in the container portion 12, merely by way of example only.

FIG. 3 shows a transverse section of a part of the container portion 12, and thus a cross section through the packaging material, as manufactured to the shape of the container portion 12. In FIG. 3, each of the external and internal surfaces 16, 18 are illustrated. It will be appreciated that in the completed container portion 12, each of the internal and external surfaces 16, 18 are exposed to a surrounding environment. The terms “internal surface” and “external surface” apply to the orientation of the respective surface 16, 18, having regard to the interior region 15 of the packaging device 10.

The packaging material includes a substrate 50 that, in this example, is in the form of a moulded pulp fibre item. In respect of the container portion 12, the finished article is to have particular geometric and shape properties. It will be appreciated that the geometric and shape properties are particular to the article, but these are a function of the article and its intended use, and not of the invention. Also in respect of the container portion 12, the substrate 50 is formed so as to be able to retain its moulded shape in an unsupported condition. In some alternative embodiments, the substrate (or the material of which the substrate is formed) may not have the capacity to retain its shape in an unsupported condition.

In this particular embodiment, the substrate 50 carries a first layer 52, a second layer 54, and a third layer 56. As shown in FIG. 3, the exposed surface of the substrate 50 is the external surface 16, and the exposed surface of the third layer 56 is the internal surface 18 of the container portion 12. As described in further detail below, each of the layers 52, 54, 56 is a functional layer that contributes in one or more ways to inhibiting transmission of fluid from the atmosphere surrounding the packaging material, through the packaging material. In this way, the layers 52, 54, 56 provide increased barrier to transmission of one or more fluids through the packaging material, when compared with the substrate 50 alone. It will be appreciated that, in the example of the packaging device 10, this increased barrier enables prolonged shelf life of goods stored internally within the container portion 12, and enclosed by the joining of the lid portion 14 to the container portion 12.

Within the packaging material, there is a first interface 58 formed at the material boundaries of the materials of the substrate 50 and the first layer 52, and a second interface 62 formed at the material boundaries of the materials of the first and second layers 52, 54. A further interface is also formed at the material boundaries of the materials of the second and third layers 54, 56. In FIG. 3, the material boundary interfaces are represented by lines, but it will be appreciated that these interfaces are three dimensional within physical packaging material of embodiments.

The first layer 52 is formed of interposing materials that include compounds that are insoluble in water. Further, the first layer 52 is a solid at Standard Ambient Temperature. In this particular example, the first layer 52 is formed of materials and at a thickness that is efficacious in inhibiting the transmission of water vapour therethrough.

Throughout this specification and the claims that follow, references to “Standard Ambient Temperature” is to be understood to be 25° C. (77° F.), in accordance with the definition of Standard Ambient Temperature and Pressure (SATP) as defined by the International Union of Pure and Applied Chemistry (IUPAC).

By way of example, the first layer 52 can be formed of carnauba wax, candelilla wax, or a blend thereof. The raw material(s) of the first layer 52 is/are applied to the substrate 50, such that a continuous layer is formed across the substrate 50.

Prior to applying the second layer 54 to the first layer 52, the first layer 52 is subjected to a surface treatment process. The surface treatment process alters the properties of the surface of the applied first layer 52 that, in the completed packaging material, defines the second interface 62 between the first and second layers 52, 54. To this end, the surface treatment process can:
improve the receptiveness of the first layer 52 to adhesion of the second layer 54,
remove contaminants on the surface of the applied first layer 52 to promote adhesion to the first layer 52, and/or
increase the surface energy of the first layer 52.

Throughout this specification and the claims that follow, unless the context requires otherwise, the terms “surface energy” and “interfacial energy” are to be understood to have identical meaning. Moreover, the term “surface energy” does not imply that a respective material boundary is exposed to atmosphere.

In some examples, the surface treatment process can alter the geometric properties of the surface of the applied first layer 52, so as to reduce the surface roughness prior to application of material from which the second layer 54 is formed.

As will be appreciated from FIG. 3, materials of the first layer 52 interpose the substrate 50, and the second layer 54.

The second layer 54 is formed of a composite material that includes additives dispersed within a linear polysaccharide medium. The additives form bonds with the linear polysaccharide medium to thereby facilitate formation of a substantially continuous film that is capable of providing a barrier to transmission of oxygen gas. The bonds between the linear polysaccharide medium and the additives may be physical bonds, and/or covalent bonds. Further, the second layer 54 is formed within the packaging material at a thickness that is efficacious in inhibiting the transmission of oxygen gas therethrough. In this way, the second layer 54 provides a barrier within the packaging material to transmission of oxygen gas.

By way of example, the linear polysaccharide medium is a low molecular weight chitosan, and the additives can include fibres. The fibres may consist of, or include cellulose fibres. The composite material may be prepared into a solution to facilitate application to the first layer 52. The solvent may be water, and/or other organic/inorganic compound(s) that is/are a liquid at room temperature. Where the solvent includes water and one or more other compounds, those other compounds are ideally highly miscible with water, if not completely miscible with water.

The solution is transferred to the exposed surface of the first layer 52, using known liquid application methodologies. The surface treatment of the first layer 52 facilitates dispersion of the solution. The film is formed by evaporating the solvent, leaving the chitosan and cellulose fibres uniformly distributed on the first layer 52. The cellulose fibre within the film supports internal stress within the chitosan film, at least during evaporation of the solvent. Alternatively or additionally, a more resilient film is formed.

As will be appreciated, the first layer 52 in this particular embodiment facilitates dispersion of the solution that includes the second layer materials during formation of the second layer 54.

In the example illustrated in FIG. 1, the protective layer 56 forms the internal surface 18 of the packaging material, and also is in contact with the second layer 54. The protective layer 56 is assembled into a substantially continuous film that provides a barrier between the second layer 54 layer and the atmosphere.

The protective layer 56 forms a barrier to water vapour, and thus inhibits interaction between materials of second layer 54 and atmospheric water vapour. Due to the presence of the protective layer 56, damage to the chitosan film of the second layer 54 by atmospheric water vapour is mitigated.

In this embodiment, the protective layer includes polymer material. In some embodiments, the protective layer includes poly(lactic-co-glycolic acid); commonly referred to generically as PLGA.

The PLGA can be formed from lactic acid and glycolic acid at a monomer ratio of approximately 50:50.

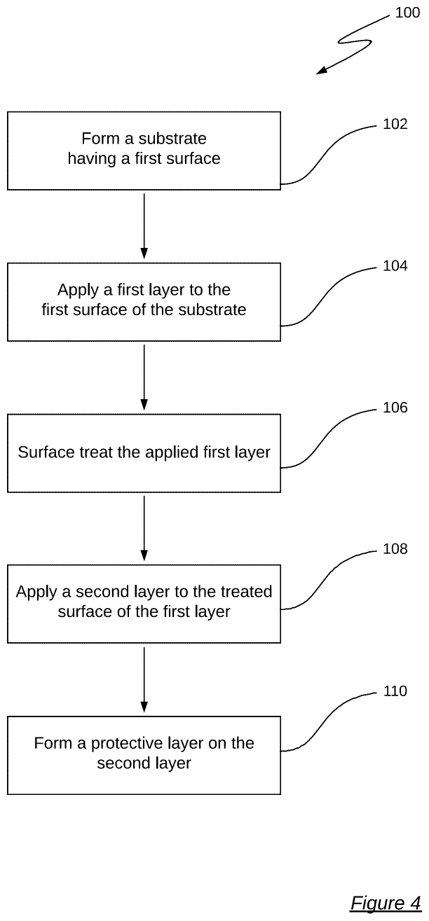

FIG. 4 is a flow chart of a method 100 for making a packaging material according to a second embodiment. With reference to the elements of the packaging material illustrated in FIG. 3, the method 100 involves:
forming a substrate 50 having a first surface—step 102;
applying a first layer 52 to the first surface of the substrate 50—step 104;
surface treating the applied first layer 52—step 106;
applying a second layer 54 on the treated surface of the first layer 52—step 108; and
forming a protective layer 56 on the second layer 54—step 110.

FIG. 5 shows an enlarged schematic representation of the substrate 50 within Region B of FIG. 3, after step 102 in the method 100 has been completed, but prior to step 104 commencing. The substrate 50 has a first surface at the completion of step 102, onto which first layer 52 is to be applied during step 104. The substrate 50 has been formed by a process that enables the substrate 50 to at least partly retain a predetermined shape during subsequent steps of the method 100. In the example of the container portion 12, the substrate 50 is non-planar. In the example of the lid portion 14, the substrate is a substantially planar sheet.

In FIG. 5, block arrow 18 indicates the direction towards what will ultimately be the internal surface 18 of the packaging material, when completed.

It will be appreciated that in subsequent steps of the method 100, the first surface will become an internal first interface 58 between the substrate 50 and the first layer 52. In FIG. 5, the substrate 50 is illustrated (schematically) in a vertical section such that the first surface is illustrated as a line. For convenience in the description relating to FIG. 5 that follows, the first surface is given the reference numeral 58.

FIG. 5 indicates the microscopic geometric variations that are present in the first surface 58 of the substrate 50. These microscopic geometric variations form peaks and valleys that define the surface roughness of the first surface 58. Further, the peaks and valleys have a height that can be measured in a direction that is normal to a planar, or non-planar reference surface. That reference surface can be an ideal surface of the actual first surface 58, another surface, or a reference surface. With respect to the peaks, the valleys form microscopic depressions in the surface 58 of the substrate 50.

The first surface 58 has a notional mean surface 60 that is an arithmetic average of the heights of the peaks and valleys within the first surface 58 and along a measurement direction. The notional mean surface 60 has a height above the reference surface, which is FIG. 5 is indicated by arrow 60_{AVG}. For ease of explanation, in FIG. 5, the reference surface is a tangential plane that intersects the internal surface 18.

Each point on the first surface 58 has a height relative to the reference surface. Further, each point on the first surface 58 has a profile height deviation from the notional mean surface 60. The profile height deviation can be expressed by the formula:

Pₐ=S_{AVG}−Hₐ

in which:
Pₐ is the profile height deviation for a point a,
S_{AVG} is the height of the notional mean surface at point a, along a measurement direction and relative to the reference surface, and
Hₐ is the height of point a, relative to the reference surface.

As will be appreciated from FIG. 5, points a₁ and a₃ are between the notional mean surface and the reference surface, and so the profile height deviations for these points are less than zero.

The material of the first layer 52 has the capacity to flow during application onto the substrate 50. Consequently, during step 104, the material of the first layer 52 can flow over the first surface 58, filling the valleys within the geometric variations that are present in the first surface. The capacity of any material in its liquid state to fill valleys within geometric variations of another surface is referred to in this specification as the “filling properties” of that liquid material. As the material of the first layer 52 cures, bonds are formed between the first layer 52 and substrate 50. The capacity of any curable material to form bonds another material is referred to in this specification as the “binding properties” of that curable material.

The material of the first layer 52 has greater capacity to fill and bind onto the substrate 50, when compared with the ability of the material of the second layer 54 to fill and bind directly onto the substrate 50.

FIG. 7 shows an enlarged schematic representation of the first layer 52 within Region C of FIG. 3, after step 106 in the method 100 has been completed, but prior to step 108 commencing. Thus, the exposed surface of the first layer 52 (which is remote from the substrate 50, is the surface that has been treated during step 106; in other words, the “treated surface”.

It will be appreciated that in subsequent steps of the method 100, the treated surface will become an internal second interface 62 between the first and second layers 52, 54. In FIG. 7, the first layer 52 is illustrated (schematically) in a vertical section such that the treated surface is illustrated as a line. For convenience in the description relating to FIG. 7 that follows, the treated surface is given the reference numeral 62.

FIG. 7 indicates the microscopic geometric variations that are present in the treated surface 62 of the first layer 52. These microscopic geometric variations form peaks and valleys that define the surface roughness of the treated surface 62. With respect to the peaks, the valleys form microscopic depressions in the treated surface 62.

The treated surface 62 also has a notional mean surface 64 that is an arithmetic average of the heights of the peaks and valleys within the treated surface 62 along a measurement direction. Each point on the treated surface 62 has a height relative to the reference surface, which in this example is also tangential plane that intersects the internal surface 18.

Although schematic, FIGS. 5 and 7 represent differences in the amplitude and period of the geometric variations between the first surface 58 and treated surface 62. In this example, the peak-to-valley heights of the peaks and valleys in the treated surface 62 are less than the peak-to-valley heights of the peaks and valleys in the first surface 58. Thus, the geometric variations of the treated surface 62 are less than the geometric variations of the first surface 58 (prior to application of the first layer 52), when measured in a direction that is normal to the reference plane.

Similarly, in this example, the lateral separation of adjacent peaks in the treated surface 62 are less than the lateral separation of adjacent peaks in the first surface 58 along respective measurement directions. Thus, the geometric variations of the treated surface 62 are less than the geometric variations of the first surface 58 (prior to application of the first layer 52), when measured in a direction that is parallel to the reference plane.

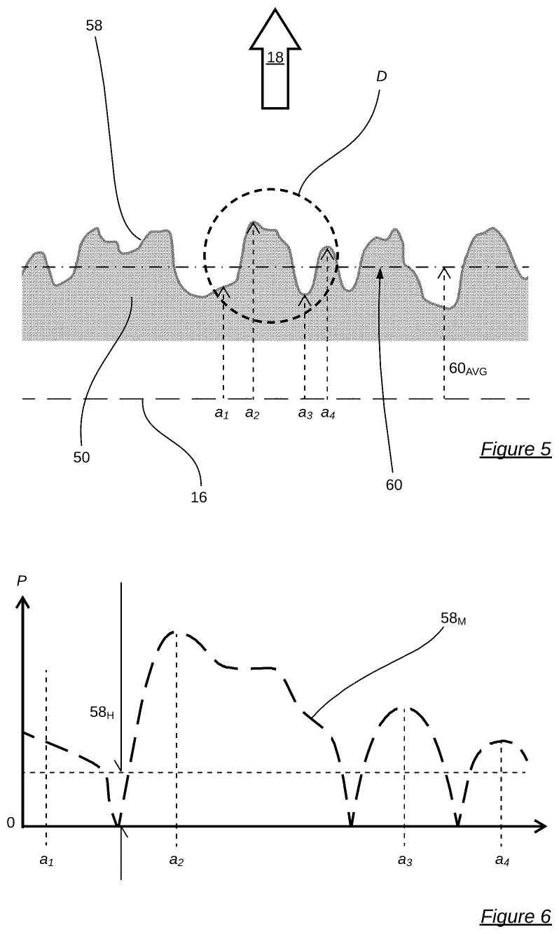

FIG. 6 is a chart showing schematically the absolute value of profile height deviations within portion D of the first surface 58 shown in FIG. 5. In FIG. 6, the absolute value of the profile height deviation for points on the first surface 58 are shown in a dashed plotted line 58M. Points that lie on the horizontal axis are those points where the first surface 58 is coincident with the notional mean surface 60. On the chart of FIG. 5, the absolute value of the profile height deviations are shown; hence, the plotted line 58M can be expressed by the formula:

P_{abs}=|S_{AVG}−Hₐ|

in which:
P_{abs} is the absolute value of the profile height deviation for a point a,
S_{AVG} is the height of the notional mean surface at point a, along a measurement direction and relative to the reference surface, and
Hₐ is the height of point a, relative to the reference surface.

FIG. 6 also indicates the mean 58_{H} of the absolute values of the profile height deviations P_{abs}.

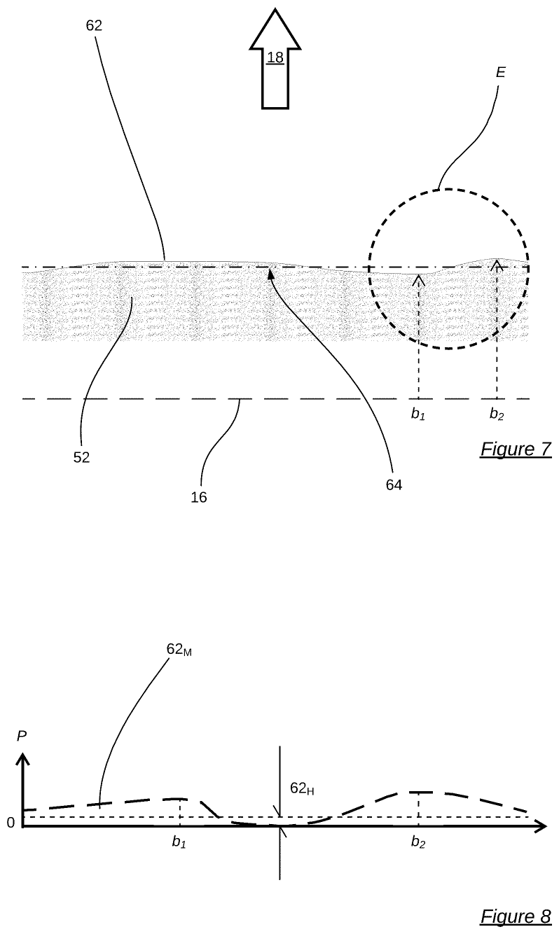

FIG. 8 is a chart showing schematically the absolute value of profile height deviations within portion E of the treated surface 62 shown in FIG. 7. In FIG. 8, the absolute value of the profile height deviation for points on the treated surface 62 are shown in a dashed plotted line 62_{M}. FIG. 8 also indicates the mean 62_{H} of the absolute values of the profile height deviations P_{abs}.

As previously stated, the surface treatment of the exposed surface of the first layer 52 in step 106 has the beneficial effect of increasing the surface energy of the first layer 52 (compared with the surface energy of the first layer 52 in its untreated state). In turn, the increased surface energy facilitates dispersion of the solution that forms the second layer 52 during step 108. Thus, at the conclusion of step 108, the second layer 52 can be uniformly distributed on the first layer 52, thereby forming a film of material that inhibits transfer of oxygen therethrough.

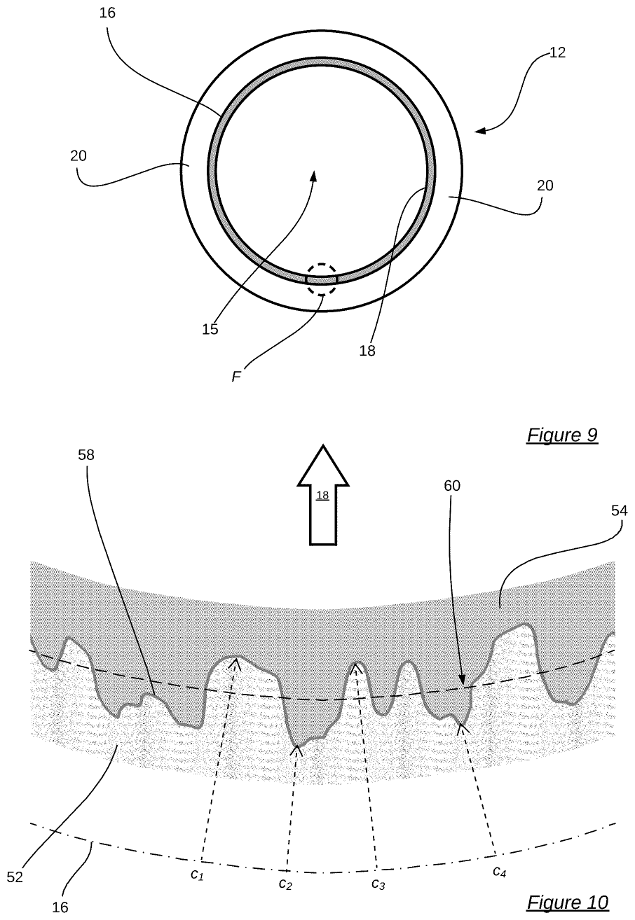

Although schematic, the charts of FIGS. 6 and 8 represent that the mean 58_{H} (of the absolute values of the profile height deviations P_{abs} in respect of the first surface 58) is less than the mean 62_{H} (of the absolute values of the profile height deviations P_{abs} in respect of the treated surface 62). FIG. 10 is an enlarged schematic representation of an internal region of the packaging material in Region F in FIG. 9, and shows parts of the substrate 50, the first layer 52, and the material boundary interface 58 therebetween. Within Region F, the external and internal surfaces 16, 18 of the container portion 12 are both arcuate.

FIG. 10 shows schematically geometric variations in the interface 58 between the substrate 50 and first layer 52, within Region F of FIG. 9, the geometric variations being present at a microscopic level. Within Region F, the container portion 12 differs in that the packaging material is curved. Accordingly, the external and internal surfaces 16, 18 are curved.

As indicated in FIG. 10, the heights of the peaks and valleys formed by these microscopic geometric variations in the material boundary interface 58 have a height is measured in a direction that is normal a local tangent plane that is co-incident with the reference surface. However, within this part of the container portion 12, the reference surface is non-planar. Accordingly, as shown in FIG. 10, in this part of the container portion 12 the notional mean surface 60 (which is shown as a dash-dot line) is also non-planar.

### EXAMPLES

The description that follows are non-limiting examples of packaging materials that the Applicant has constructed for evaluation purposes, and of the procedures for production of those packaging materials. For convenience, the terminology of packaging material described in reference to FIG. 3 is used throughout the following description.

In one example, a substrate of moulded pulp fibre was formed according to a known thermoforming process from a slurry of pulped bagasse fibres.

Interposing materials were applied to a surface of the substrate. To this end, a first set of compounds was formed into a hot “bath” (in other words, a reservoir) of liquid material. The first set of compounds included candelilla wax, with additives of:
surfactant, in the form of sorbitol mono-oleate at a ratio in the range of 1% to 5% by weight to the wax, and
fumed silica at a ratio in the range of 0.5% to 2% by weight to the wax.

The hot bath of liquid material was heated to 100° C., and mixed to disperse the additives through the liquified wax.

The liquid material was applied to a surface of the moulded pulp fibre substrate to obtain a film thickness of the order of 30 to 45 μm. The first set of compounds were allowed to cool to solidify on the substrate. Thus, a first layer was applied to the surface of the substrate.

The applied first layer was subjected to surface treatment. In some examples, the step of surface treating the applied first layer involved a chemical treatment of the exposed surface of the applied first layer, in order to induce a change in the properties of the exposed surface. This chemical treatment involved bringing the exposed surface of the applied first layer into contact with one or more compounds.

In some trials, the chemical treatment is understood to have induced structural changes in a boundary sub-layer at the exposed surface. In some other trials, the chemical treatment is understood to have caused a chemical reaction between the first layer material and the chemicals, whereby a sub-layer is created within the first layer materials adjacent the exposed surface.

In some trials, the chemical treatment involved depositing further interposing material, in the form of modifying agents, onto the surface of the applied first layer.

In some examples, the modifying agents were used to form a mixture with the first set of compounds in a boundary region of the applied first layer. In these examples, the applied first layer beneath the boundary region remained, and the mixture of first and second sets of compounds within that boundary region formed a second intermediate layer. Thus, the second intermediate layer contained the first set of compounds and the modifying agents. The unchanged interposing materials of the applied first layer remained beneath the second intermediate layer, thus establishing a notional first intermediate layer.

In some other examples, the modifying agents were a discrete second set of compounds that had minimal interaction with the first set of compounds.

Trials have used chemicals including ozone gas, pectins in solution, polyether compounds (including polyethylene glycol) in solution. Further, chemical solutions have used water and volatile liquids as the solvents, whereby the liquid fraction is capable of evaporating during the surface treatment step.

A mixture of composite materials for the second layer was formed. To this end, a preliminary solution was created by combining powdered Chitosan having a molecular weight between 10 and 100 kDa, with an acidic solvent at a ratio in the range of 3 to 10% Chitosan by weight. In this example, the acidic solvent included de-ionised water that was acidified by a mild organic acid having a strength of the order of 2.5 to 5.5 pKa.

In some trials, plasticiser was incorporated into the preliminary solution at a ratio of 1% to 5% by weight. Several plasticisers were trialled, including ester of citric acid.

A secondary solution of refined bagasse fibre and de-ionised water was formed, and then combined with the acidic solvent. The secondary solution of refined bagasse fibre and de-ionised water had a ratio of approximately 5% fibre by weight. The secondary solution was added at a ratio in the range of 15% to 35% to the preliminary solution. The combined preliminary and secondary solutions were mixed to give Chitosan to fibre ratios in the range of 2:1 to 4.5:1, by dry weight. The composite materials for the second layer were then mixed at an elevated temperature (of approximately 40° C.) for an extended period in order to obtain a substantially homogeneous distribution of composite materials in solution, and then transferred to a bath.

The workpiece, now consisting of the substrate with the formed first and second intermediate layers, was dipped into the bath containing the composite materials to coat the first layer. The composite materials were then exposed to infrared light energy as the liquid component evaporated to form a film. The mixture of composite materials were applied at amounts sufficient to form the film having a thickness of the order of 15 to 30 μm.

A mixture of materials for the third layer was formed in a bath. The mixture included poly(lactic-co-glycolic acid) in a ratio of lactic acid and glycolic acid of the order of approximately 50:50 dispersed in an acetone solvent at a ratio of 5% to 20% by weight. The PLGA component had a molecular weight of between 5 and 150 kDa.

The workpiece, now consisting of the substrate with the formed first and second layers, was dipped into the bath containing the third layer materials to coat the second layer. The workpiece was then transferred to an oven that was heated to a temperature exceeding the glass transition point of the PLGA component. The workpiece remained within the elevated temperature as the solvent was evaporated, whilst the PLGA component was tempered and a film formed. The mixture of materials for the third layer was applied at amounts sufficient to form a film having a thickness of the order of 5 to 50 μm.

Once removed from the oven, the workpiece was then cooled to room temperature to complete production of the packaging material. The packaging material was then analysed and evaluated.

It will be understood that ranges used in the embodiments and examples described herein can be chosen, in various combinations, to obtain different desired properties of water vapour and oxygen transmission rates (WVTR and OTR).

Throughout this specification and the claims that follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-69. (canceled)

70. A packaging material comprises:
a substrate; and
an oxygen transmission inhibiting layer that is carried by the substrate, the oxygen transmission inhibiting layer being formed of a composite material comprising a linear polysaccharide medium within which one or more additives are dispersed to thereby facilitate formation of a substantially continuous film of the composite material that is capable of providing a barrier to transmission of oxygen gas,
wherein the oxygen transmission inhibiting layer is configured within the packaging material at a thickness that is efficacious in inhibiting the transmission of oxygen gas therethrough; and
wherein at least one of the additives forms bonds with the linear polysaccharide medium, and wherein the bonds contribute to at least one of: the formation, and resilience of the substantially continuous film.

71. The packaging material according to claim 70, wherein the linear polysaccharide medium is formed by a process involving at least partial deacetylation of a long-chain polymer of an amide derivative of monosaccharide glucose.

72. The packaging material according to claim 70, wherein the linear polysaccharide medium is chitosan.

73. The packaging material according to claim 72, wherein the chitosan has a molecular weight in the range of 10 to 100 kilodaltons.

74. The packaging material according to claim 70, wherein the additives of the composite material include plant-derived compounds in the form of cellulose, and wherein the cellulose is substantially in fibre form.

75. The packaging material according to claim 70, further comprising at least one interposing material that at least partly separates the composite material of the oxygen transmission inhibiting layer from the substrate,
wherein the interposing material inhibits transmission of water vapour through the packaging material.

76. The packaging material according to claim 75, wherein the interposing material is assembled into first intermediate layer that:
includes a first set of one or more compounds, at least one of which is insoluble in water,
is a solid at Standard Ambient Temperature; and
is configured within the packaging material at a thickness that is efficacious in inhibiting the transmission of water vapour therethrough; and
wherein the first set of compounds includes one or more base compounds, and wherein each base compound is an ester of a long-chain alcohol and a fatty acid.

77. The packaging material according to claim 70, further comprising a protective layer that is assembled into a substantially continuous film to provide a barrier between the oxygen transmission inhibiting layer and the atmosphere to thereby inhibit interaction between atmospheric water vapour and the oxygen transmission inhibiting layer.

78. The packaging material according to claim 77, wherein the protective layer defines a surface of the packaging material.

79. The packaging material according to claim 77, wherein the protective layer includes poly(lactic-co-glycolic acid).

80. The packaging material according to claim 79, wherein the poly(lactic-co-glycolic acid) is formed from lactic acid and glycolic acid, with a greater proportion of lactic acid monomer present at polymerization.

81. The packaging material according to claim 70, wherein the substrate is formed of pulp fibres that have been processed so as to be assembled into a predetermined shape, and treated to form bonds between the pulp fibres within the substrate,
wherein the substrate is able to at least partly retain its shape in an unsupported condition.

82. A packaging device having two or more component parts, at least one of which is formed of packaging material as defined in claim 70, the packaging device being shaped and/or configured to be assembled to define an interior region within which goods are to be contained,
wherein the oxygen transmission inhibiting layer is positioned between the substrate and the interior region.

83. A packaging device having two or more component parts, at least one of which is formed of packaging material as defined in claim 70, the packaging device being shaped and/or configured to be assembled to define an interior region within which goods are to be contained,
wherein the oxygen transmission inhibiting layer is positioned between the substrate and the interior region,
the packaging device further comprising:
a container portion having a body that defines the interior region, and an annular flange surrounding an entrance to the interior region, and
a lid portion with a peripheral edge region that is to be joined to the annular flange to thereby enclose the interior region,
wherein the container and lid portions are formed separately, and when so joined form a capsule within which to contain an aliquot of the goods, and
wherein at least one of the container portion and the lid portion are formed of said packaging material.

84. A packaging material comprising:
a substrate; and
a protective layer that includes poly(lactic-co-glycolic acid), that is assembled into a substantially continuous film that is carried by the substrate, and that defines a surface of the packaging material,
wherein the protective layer has a thickness that is efficacious in inhibiting interaction between atmospheric water vapour and the packaging material beneath the protective layer.

85. The packaging material according to claim 84, wherein the poly(lactic-co-glycolic acid) is formed from lactic acid and glycolic acid at a monomer ratio of approximately 50:50.

86. The packaging material according to claim 84, further comprising one or more intermediate layers between the substrate and the protective layer, wherein the intermediate layers are efficacious in inhibiting the transmission of at least one of: oxygen gas, and water vapour therethrough.

87. The packaging material according to claim 84, wherein the substrate is formed of pulp fibres that have been processed so as to be assembled into a predetermined shape, and treated to form bonds between the pulp fibres within the substrate,
wherein the substrate is able to at least partly retain its shape in an unsupported condition.

88. The packaging material according to claim 84, wherein the substrate is formed of pulp fibres that have been processed so as to be assembled into a predetermined shape, and treated to form bonds between the pulp fibres within the substrate,
wherein the substrate is able to at least partly retain its shape in an unsupported condition.

89. The packaging device having two or more component parts, at least one of which is formed of packaging material as defined in claim 84, the packaging device being shaped and/or configured to be assembled to define an interior region within which goods are to be contained,
wherein the protective layer defines a surface of the interior region.
